(19) United States
(12) Patent Application Publication
(10) Pub. No.: US 2004/0100920 A1
(43) Pub. Date: May 27, 2004

(54) Method for regulating power and for channel allocation in downlink and/or uplink connections of packet data services in a radio communications system, and radio communications system for carrying out said method

(76) Inventors: Carsten Ball, Rheinzabern (DE); Kolio Ivanov, Munchen (DE)

Correspondence Address: STAAS & HALSEY LLP, SUITE 700, 1201 NEW YORK AVENUE, N.W., WASHINGTON, DC, 20005, US

(21) Appl. No.: 10/311,208

(22) PCT Filed: Jun. 13, 2001
(86) PCT No.: PCT/DE01/02213

(30) Foreign Application Priority Data
Jun. 15, 2000 (DE) 10029427.8

(51) Int. Cl. H04B 7/185

(52) U.S. Cl. 370/318; 370/329

(57) ABSTRACT

Transmission power in data transmission of packet data via a radio interface between a base station and subscriber stations is regulated by subdividing the active data being transmitted via a carrier into a plurality of packet data traffic channels that transmit in parallel. This effectively regulates the transmission power in the downlink direction. To this end, different transmission powers in the downlink direction of the base station to the subscriber station(s) are allocated to the packet data traffic channels for the transmission of active data. A packet data traffic channel with corresponding allocated transmission power range is allocated to every subscriber station that has an individual transmission power requirement in the downlink direction, similar or equal modulation and coding patterns are allocated to every subscriber station on the packet data traffic channel.

The invention relates to a method having the features of the precharacterizing part of patent claim 1, particularly to a method for power regulation for downlinks and/or uplinks for packet data services in a radio communication system, and to a radio communication system having the features of the precharacterizing part of patent claim 12 for carrying out the method.

In radio communication systems, information, for example speech, image information or other data, is transmitted via a radio interface between the sending station and the receiving station (base station and subscriber station) using electromagnetic waves. In this context, the electromagnetic waves are radiated at carrier frequencies situated in the frequency band provided for the respective system. For future mobile radio systems using CDMA or TD/CDMA transmission methods over the radio interface, for example the UMTS (Universal Mobile Telecommunication System) or other 3^{rd} generation systems, provision is made for frequencies in the frequency band of approximately 2000 MHz.

In existing mobile radio networks based on the GSM standard (GSM: Global System for Mobile Communications) using frequencies between 400 MHz and 2.0 GHz, novel data services such as the packet data service GPRS (General Packet Radio Service) and its extension EDGE/EGPRS (Enhanced Data Rates for GSM Evolution/Enhanced GPRS) are currently being introduced. In this context, transmission in the mobile radio network takes place not on a connection-oriented basis or on a circuit-switched basis, but rather in the form of packet data. This type of transmission makes better use of the given transmission resources in the mobile radio network through multiplexing, for example.

In the case of the TDMA method, such as GSM or else TDD UMTS, a TDMA component (TDMA: Time Division Multiple Access) has provision for splitting a broadband carrier having, by way of example, a frequency range of 5 MHz in the case of UMTS or a narrowband carrier having, by way of example, 200 kHz in the case of GSM into a plurality of timeslots of equal duration. In the case of TDD-UMTS (TDD: Time Division Duplex), on the same carrier frequency, some of the timeslots are used in the downlink DL from the base station to the subscriber station and some of the timeslots are used in the uplink UL from the subscriber station to the base station. The GSM standard provides the uplink and the downlink with eight respective timeslots on two 200 kHz carrier frequencies separated by a duplex spacing. For data transmission for the packet data services GPRS/EGPRS based on the GSM standard, each timeslot is allocated a packet data traffic channel PDTCH. All packet data traffic channels are unidirectional. Transmission takes place either in the uplink for packet data transmission from the subscriber station to the base station or in the downlink for packet data transmission from the base station to the subscriber station. In this case, a packet data traffic channel can be allocated to a subscriber permanently for a particular time interval in the case of static channel allocation (fixed allocation based on GSM 04.60) or can be allocated to a plurality of subscribers at the same time in the case of dynamic channel allocation (dynamic allocation based on GSM 04.60), i.e. a plurality of subscribers are served on this packet data traffic channel (multiplexing). This applies to the uplink and downlink independently of one another. It is of crucial significance in this context that each subscriber station needs to receive and correctly decode all packets transmitted in the downlink, “RLC blocks”, since it does not have access to any information regarding when a block intended for this subscriber station is transmitted. The data packets for the subscriber station are provided with a unique address in the downlink using an identifier TFI (Temporary Flow Identifier) contained in the radio link control/medium access RLC/MAC block header (RLC/MAC: Radio Link Control/Medium Access Control header), said identifier being allocated to the packet data flow TBF (Temporary Block Flow) for data transmission in the subscriber station's downlink during traffic channel allocation. For collision-free use of the packet data traffic channel with dynamic channel allocation in the uplink, the state of the uplink is used, using an uplink identification flag USF (Uplink State Flag) which is allocated to the packet data flow (TBF) for data transmission in the subscriber station's uplink during traffic channel allocation. For this reason, all subscriber stations multiplexed on the packet data traffic channel in the uplink need to be able to receive and correctly decode the uplink state flag, contained in the radio link control/medium access (RLC/MAC) block header, for each radio link control (RLC) block transmitted in the downlink on the same timeslot.

The packet data traffic channels situated on the message or information carrier (BCCH) in the case of GSM/GPRS/EGPRS, for example, are radiated at constant power in this context. When transmitting on the packet data traffic channels on other carriers, generally no power regulation is used in the downlink either (Downlink Power Control), since each packet data traffic channel can be used by a plurality of subscribers at the same time (Multiplexing) and a downlink involves the transmitter power on the packet data traffic channel being adjusted to the subscriber station with the greatest path loss, i.e. generally to the station which is furthest away. This is done in this way since, during multiplexing, each subscriber station needs to be able to receive and correctly decode all packets transmitted in the downlink, since it does not have access to any information regarding when a packet intended for this subscriber station is transmitted. In addition, each subscriber station needs to read the uplink state flag (USF) information held in the radio link control/medium access (RLC/MAC) header in each block sent in the downlink so that splitting of the resource in the uplink over a plurality of subscriber stations (multiplexing) can work without collisions.

The likelihood that multiplexing arbitrary subscriber stations in a cell on a packet data traffic channel will always involve a “long-distance” subscriber with a high level of path loss is very high. This is so because, assuming a random even distribution for the subscriber stations in the cell with the approximated area of a circle or hexagon, 75% of the subscribers are outside half the cell radius and only 25% are inside half the cell radius. This means that it is imperative for the base station subsystem (BSS) to have a suitable strategy for allocating the subscribers to the packet data traffic channels.

To date, the transmitter power for the downlink, i.e. the base station's transmitter power, on a packet data traffic channel is set uniformly for all subscriber stations served both on this packet data traffic channel for the downlink and on the corresponding packet data traffic channel, situated on the same timeslot, for the uplink at the same time (multiplexing), such that even the subscriber station with the weakest received power can still receive everything correctly. However, this generally means that no or only very restricted power regulation is possible.

The object of the invention is to propose a suitable method for power regulation in downlinks in a radio communication system or in a corresponding communication system.

This object is achieved by the method having the features of patent claim 1 and by the communication system having the features of patent claim 12.

Advantageous refinements are the subject matter of dependent claims.

The fact that the packet data traffic channels for user data transmissions can each be allocated different transmitter powers in the downlink from the base station to the subscriber station(s) provides a very favorable approach to achieving the power regulation in the downlink for packet data services in the GSM network, such as GPRS or EGPRS, or in other networks, and above all permits real power regulation on packet data traffic channels.

At the same time, the method permits or involves a channel allocation strategy for the subscriber stations on packet data traffic channels so as to increase the performance at the same time as a result. Thus, each of the subscriber stations with its respective own transmitter power requirement in the downlink is advantageously allocated to a packet data traffic channel with an appropriately allocated transmitter power range. In this case, subscriber stations which each have a similar transmitter power requirement in the downlink can be respectively allocated to a common packet data traffic channel with an appropriately allocated transmitter power range.

Determining the transmitter power requirement in the downlink for the subscriber station(s) on the basis of the path loss during data transmission in the uplink, particularly on the basis of the path loss during signalling in the uplink via a channel for direct random access to the base station by the subscriber stations, is particularly simple to implement, without special precautions in the form of new devices needing to be introduced. This advantageously also involves determining the transmitter power requirement by taking into account the service required and/or the data throughput required and/or the quality of service required.

If the transmitter power requirement in the downlink has changed, the subscriber station(s) is/are advantageously reallocated, which means that it is possible to update the allocations in line with the respective ambient conditions which are currently valid etc.

Over all packet data traffic channels, the total transmitter power of the base station or base transceiver station is reduced, which reduces the interference in the radio network and hence increases capacity.

Another particularly advantageous method step is evaluation of the access burst reception line by the base station when first allocating the modulation and coding scheme to the subscriber station. The modulation and/or coding scheme can also be allocated to the subscriber station(s) on the basis of the transmitter power requirement in the downlink, as appropriate. This is so because, since different modulation and/or coding schemes each require a particular signal-to-noise ratio, the most suitable modulation and/or coding scheme is likewise dependent on the path loss between base station and subscriber station and on the interference conditions in the cell.

In addition, the strategy of allocating the subscriber stations with identical or similar modulation and coding schemes to identical packet data traffic channels relieves the load on the interface (in the case of GSM, the “Abis” interface) between base station controller and base transceiver stations. In this case, the method takes into account the entire available Abis capacity of a base station and the respective Abis capacity allocated to a packet data channel.

In this context, subscriber stations are to be understood to mean all conceivable stations, particularly mobile and fixed radio stations and data terminals for connecting a computer unit.

An exemplary embodiment is explained in more detail below with reference to the drawing, in which:

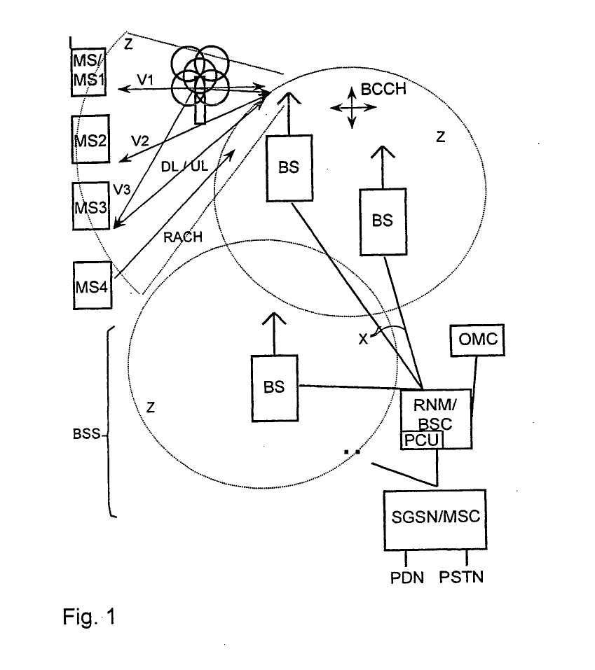

FIG. 1 shows a block diagram of a known mobile radio system,

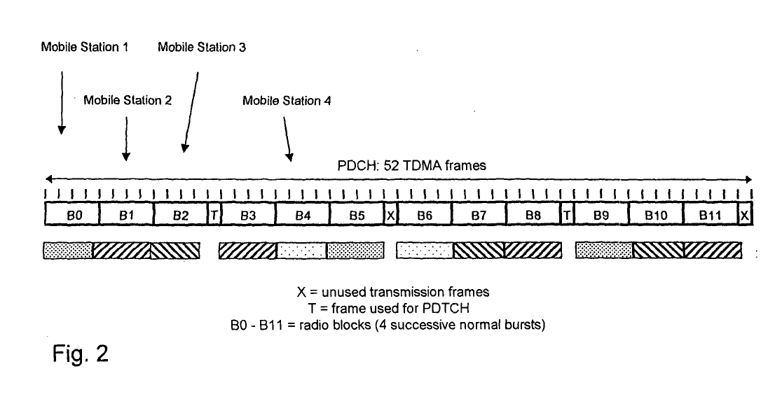

FIG. 2 shows a schematic illustration of the frame structure of a GSM/GPRS packet data channel, and

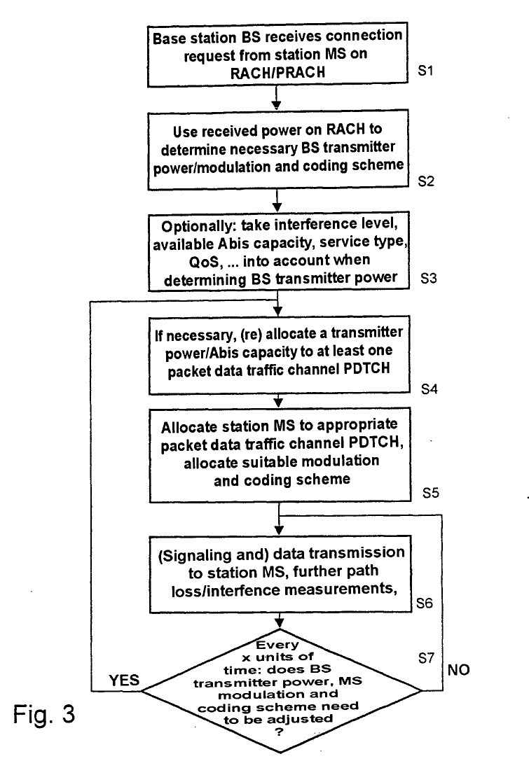

FIG. 3 shows a flowchart for a power regulation method.

The mobile radio system shown in FIG. 1 as an example of a radio communication system comprises a multiplicity of mobile switching centers MSC and service and access network nodes SGSN (Serving GPRS Support Node) which are networked to one another and set up access to a landline network PSTN or to a packet data network PDN. In addition, these mobile switching centers MSC are connected to at least one respective device RNM/BSC for allocating radio resources. Each of these devices RNM in turn allows connection to at least one base station BS. Such a base station BS can use a radio interface to set up a connection to subscriber stations, e.g. mobile stations MS or other mobile and fixed terminals. Each base station BS forms at least one radio cell Z. Sectorization or hierarchical cell structures involve each base station BS also serving a plurality of radio cells Z. The base stations and the devices controlling them form a base station system (BSS).

FIG. 1 shows connections V1, V2, V3 existing by way of example for a further mobile station MS to transmit user information and signalling information between mobile subscriber stations MS and a base station BS and a request for resource allocation or a short acknowledgement message in an access channel (P)RACH ((Packet) Random Access CHannel). It also shows an organization channel (BCCH: Broadcast Control CHannel) which is provided for transmitting user and signalling information at a defined transmitter power from each of the base stations BS for all mobile stations MS.

An operation and maintenance center OMC provides control and maintenance functions for the mobile radio system or for portions thereof. The functionality of this structure can be transferred to other radio communication systems, particularly for subscriber access networks with wireless subscriber access.

An exemplary basic structure for radio transmission of packet data on a packet data channel PDCH in GPRS/EGPRS systems can be seen in FIG. 2.

The GSM carrier with a bandwidth of 200 kHz is split into eight timeslots. A packet data channel PDCH occupies precisely one timeslot, which is again split into 12 radio blocks B0, . . . , B11, each having four bursts. A plurality of subscriber stations MS are multiplexed on the packet data channel PDCH by virtue of packet allocation units (schedulers) in the base station subsystem BSS respectively allocating them the appropriate radio blocks B0, . . . , B11 in succession.

To transmit services at high data rates, a plurality of physical resources are generally combined to form a logical channel. Subscriber stations having multi-timeslot capability (multislot mobiles) can involve a plurality of packet data channels PDCHs (or timeslots) being enabled in parallel in this case, in line with the GSM/GPRS/EGPRS standards for a subscriber station. By way of example, for a service at 144 kbit/s in the uplink and downlink, the GSM packet data service GPRS/EGPRS respectively requires up to eight physical resources (PDCHs/GSM timeslots) per subscriber station MS in parallel.

The data on a radio block B0, . . . , B11 are coded to different degrees depending on the allocated subscriber station MS and its path loss with respect to the base station BS or the latter's antenna arrangement, i.e. light coding involves a large number of user data bits being transmitted with a high signal-to-noise ratio on the receiver, and heavy coding involves correspondingly fewer user data bits being transmitted with a low signal-to-noise ratio. In other words, the individual connections on one and the same packet data channel PDCH are respectively allocated a dedicated modulation and coding scheme which also depends on the signal-to-noise ratio (reception level and interference level) and naturally also on the demanded quality of service QoS.

Since, depending on the modulation and coding scheme, different numbers of user data bits are transmitted per radio block B0, . . . , B11 on the same packet data channel PDCH, the bandwidth on the Abis interface X between base station BS and base station controller BSC also varies accordingly from radio block B0, . . . , B11 to radio block. It is therefore expedient to allocate connections using the same modulation and coding scheme to the same packet data channel PDCH, since this means that the total capacity of the Abis interface X is minimized in total across all connections. At the same time, the sum of the Abis capacities of all individual packet data channels PDCHs must not exceed the total Abis capacity available.

At the same time, allocation of the same modulation and coding schemes to subscribers with similar path loss and allocation of said subscribers to the same packet data channel PDCH allow the same transmitter power to be set on this packet data channel PDCH, since this means that all the subscribers will achieve a similar signal-to-noise ratio on the receiver.

As can be seen from FIG. 3, subscriber stations MS with similar path loss are allocated to the same packet data traffic channel PDTCH (step S5).

In this case, they are allocated automatically by the base station system. When the base station BS receives an access request from a subscriber station MS (Step S1), the base station BS determines the necessary transmitter power for transmission in the downlink DL on the basis of the previously measured reception field strength of the access burst on the random access channel PRACH/RACH (Uplink Random Access Channel), and interference measurements (step S2). Since all the subscriber stations MS in a cell Z use the maximum transmitter power permitted in the cell Z for access, which are transmitted via the message channel BCCH using the system information messages, the path loss from the mobile subscriber station MS to the base station BS can be clearly determined by the base station BS.

Advantageously, the channel allocation by the base station BS can additionally take into account the data throughput requested by the subscriber station MS or the demanded quality of service (=>average+peak throughput) and also the radio priority thereof (step S3).

The base station BS and the base station controller BSC can now allocate transmitter powers (or, indirectly from the point of view of the subscriber stations MS, transmitter power ranges) to one or more of the packet data traffic channels (step S4). These allocations can advantageously be updated, e.g. when the network utilization, the quality of the radio link or the range of a large number of subscriber stations MS changes over time.

The subscriber station MS can now be allocated to a packet data traffic channel PDTCH having an appropriate transmitter power (step S5). Following the corresponding signalling to the subscriber station MS, the packet data traffic channel PDTCH allocated thereto can be used to transmit data at precisely the transmitter power which is required for safe transmission (step S6).

Furthermore, the path loss information can also be used by the network to allocate a suitable, initial modulation and coding scheme to the subscriber station MS at the start of the flow of packet data. The modulation and coding scheme can then still change in accordance with the channel conditions during data transmission, as a result of link adaptation methods. It may then be necessary to reallocate the subscriber station MS to another packet data channel PDCH (“Intracell handover”).

If link adaptation methods become necessary, e.g. on account of increased path loss owing to the subscriber station MS moving away from the base station BS, the base station BS can allocate the subscriber station MS to another packet data traffic channel PDTCH, which is more suitable on the basis of the above criteria, using a process controlled by a suitably equipped network device (step S7).

In the case of packet data services in the GSM network, e.g. GPRS, the controller for the air interface adopts a packet data controller PCU (Packet Control Unit) in the base controller BSC.

The packet data controller PCU has an appropriate algorithm implemented in it which processes the reception power of the access burst coming from the subscriber station MS. The packet data traffic channel PDTCH and the modulation and coding scheme are then allocated when the packet data link is set up using the otherwise customary packet data service allocation message for downlinks/uplinks (PACKET UPLINK/DOWNLINK ASSIGNMENT MESSAGE).

The method works both for the downlink and for the uplink. For the uplink, the transmitter power setting is calculated in the base station BS and is communicated to the subscriber station MS, and the allocation strategy for the packet data channels PDCHs and the allocation of the modulation and coding schemes are implemented in the same way.

On account of the path loss usually being the same throughout the duration of the connection, the subscriber stations MS on a packet data traffic channel PDTCH will generally or very likely use the same modulation and coding scheme throughout the entire data transmission. This has an advantageous effect on the (Abis) interface X between the base station BS in question and the base station controller BSC. This is because the latter needs to reserve more bandwidth for the packet data controller PCU in the base station controller BSC [lacuna] frames or transmission blocks for packet data traffic channels PDTCH with higher coding schemes for packet data services, such as GPRS/EGPRS, than for voice channels based on the GMS standard, which request the necessary data rate (GSM Full Rate Voice Channel/16 kbps TRAU Frame). Accordingly, capacity is saved on the Abis interface X between base station BS and base station controller BSC, since a very good utilization level is made possible when multiplexing the data from subscriber stations MS using the same data throughput/the same modulation and coding scheme, particularly for the Abis interface X. This is so because dynamic changeover of the Abis capacity per radio block B0, . . . , B11 on a packet data traffic channel PDTCH, e.g. from a first transmission function at 64 kbps for the subscriber station MS1 to a second transmission function at 32 kbps for the subscriber station MS2, and then to the first transmission function at 64 kbps for the subscriber station MS3 and, via the second transmission function at 32 kbps for the subscriber station MS4, back to the first transmission function at 64 kbps for the subscriber MS1 again, is not possible for reasons of time and on account of changeover losses (lost data blocks). The Abis interface X between base station BS and base station controller BSC is utilized only to half its capacity when transmitting the data from the subscriber stations MS2 and MS4. It is more advantageous to put the subscriber stations MS1 and MS3, each having 64 kbps data packet controller frames (PCU frames), and subscriber stations MS2 and MS4 with 32 kbps data packet controller frames onto separate packet data traffic channels PDTCH.

1. A method for transmitter power regulation for user data transmission of packet data via a radio interface between a base station (BS) and one or more subscriber stations (MS), particularly data terminal equipment,
where the user data transmission is made using a carrier which is divided into a large number of packet data traffic channels (PDTCH) transmitting in parallel, characterized in that the packet data traffic channels (PDTCH) for user data transmissions can each be allocated (step S4) different transmitter powers in the downlink (DL) from the base station (BS) to the subscriber station(s) (MS) and/or in the uplink (UL) from the subscriber station (MS) to the base station (BS).

2. The method as claimed in claim 1 in which each of the subscriber stations (MS) with its own respective transmitter power requirement in the downlink (DL) is allocated (step S5) to a packet data traffic channel (PDTCH) with an appropriately allocated transmitter power range.

3. The method as claimed in claim 1 or 2, in which subscriber stations (MS) with a similar transmitter power requirement in the downlink (DL) are respectively allocated (step S5) to a common packet data traffic channel (PDTCH) with an appropriately allocated transmitter power range.

4. The method as claimed in one of claims 2 or 3, in which the transmitter power requirement in the downlink (DL) for the subscriber station(s) (MS) is determined (step S2, step S6) on the basis of the path loss during data transmission or signalling in the uplink (UL).

5. The method as claimed in one of claims 2 and 3, in which the transmitter power requirement in the uplink (UL) for the subscriber station(s) (MS) is determined (step S2, step S6) on the basis of the path loss during signalling in the uplink via a channel (RACH/PRACH) for direct random access to the base station (BS) by the subscriber station(s) (MS).

6. The method as claimed in one of claims 2 to 5, in which the transmitter power requirement is determined (step S3) by taking into account the service required and/or the data throughput required and/or the quality of service (QoS) required and/or the interference situation prevailing in the cell.

7. The method as claimed in one of claims 2 to 6, in which a modulation and/or coding scheme is allocated to the subscriber station(s) (MS) on the basis of the transmitter power requirement in the downlink (DL).

8. The method as claimed in claim 7, in which reallocation of the modulation and coding scheme to a connection is dependent on the transmitter power on neighboring packet data traffic channels (PDCH) for the same base station (BS).

9. The method as claimed in one of claims 2 to 8, in which the subscriber station(s) (MS) are reallocated (step S7, S4, S5) when there is a change in the transmitter power requirement in the downlink (DL).

10. The method as claimed in one of claims 2 to 9, in which capacity utilization on the interface (X) between base station (BS) and base station controller (BSC) is taken into account when allocating the transmitter power to at least one of the packet data traffic channels (PDCH), when allocating the subscriber station(s) (MS) to the packet data traffic channels (PDCH) and/or when allocating modulation and coding schemes to the packet data links.

11. The method as claimed in one of the preceding claims, in which the packet data traffic channel (PDTCH) or a modulation and coding scheme for the subscriber station(s) (MS) is allocated using packet data service allocation messages for downlinks and uplinks.

12. A radio communication system, particularly for carrying out a method for transmitter power regulation as claimed in one of the preceding claims, having
at least one base station (BS);
one or more subscriber stations (MS), particularly data terminal equipment,
a radio interface having at least one carrier for transmitting user data in the downlink from the base station (BS) to the subscriber station(s) (MS),
where the carrier is divided into a large number of packet data traffic channels (PDTCH) transmitting in parallel, characterized in that the base station (BS) has, for user data transmissions in the downlink (DL), a transmitter power controller (PCU) for transmitting at different transmitter powers on the packet data traffic channels (PDTCH).
